(19) United States
(12) Patent Application Publication
(10) Pub. No.: US 2008/0125186 A1
(43) Pub. Date: May 29, 2008

(54) Bluetooth earphone capable of switching between multiple connections

(76) Inventors: Heng-Hsin Chen, Taoyuan City (TW); Yao-Hui Lee, Hualien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/477,359

(22) Filed: Jun. 30, 2006

(51) Int. Cl. H04M 1/02

(52) U.S. Cl. 455/569.1; 455/41.2; 455/73

(57) ABSTRACT

A Bluetooth earphone capable of switching between multiple connections is provided. The claimed Bluetooth earphone has a transceiver, a micro-processing unit, a memory storing unit, and a switching module. The transceiver is used to receive wireless signals transmitted from one or more remotely connected devices. Moreover, the micro-processing unit is used to receive the wireless signals and allocate a plurality of service units corresponding to the remotely connected devices. Moreover, the wireless signals received by the micro-processing unit are stored by the memory storing unit, and provide access to the service units. Furthermore, the switching module electrically connected with the micro-processing unit is used to switch between the chosen service units. Thereby, the Bluetooth earphone can receive multiple connections from a plurality of remotely connected devices.

### BACKGROUND OF THE INVENTION

1. Field of the Invention

The present invention relates to a Bluetooth earphone, and more particularly to the Bluetooth earphone that can switch between multiple connections.

2. Description of Related Art

With the development of wireless technologies in recent years, there is a growing tendency towards short-distance wireless transmission. The technology of short-distance wireless transmission provides users with more convenient services. More particularly, an original standalone device can enter a network environment easily via Bluetooth technology.

Due to the prosperous development of the consumer electronics and communication products, almost the products have the functionalities benefited greatly from the technology of built-in Bluetooth transmission, which is used to transmit data between different electronic devices, and is increasingly considered a basic and necessary function by consumers. The technology of Bluetooth transmission is primarily used for storing and backing up data on communication products, such as household telephones, mobile phones and Internet phones. Moreover, a hands-free device receives signals sent by Bluetooth equipped devices and is often implemented via a Bluetooth earphone.

However, the above-mentioned Bluetooth earphone can't connect synchronously with more than one Bluetooth-connectible devices which have the same Bluetooth Profile. Accordingly, if the Bluetooth earphone desires to connect with another hand-free device, for example an Audio Gateway or a Bluetooth VoIP-dongle, it must break the first connection before connecting with the second device. Given the current situation of so many people owning many communication products that utilize Bluetooth technology, the above limitation is inconvenient and worthy of improvement.

### SUMMARY OF THE INVENTION

In view of the foregoing drawbacks, the present invention provides a Bluetooth earphone that can communicate with multiple remotely connected devices simultaneously. There is a switching module provided in the Bluetooth earphone that can be used to switch between various remotely connected devices with headset (or handfree) profile.

For achieving the above scheme, the Bluetooth earphone capable of switching between multiple connections of the present invention is provided, and includes a transceiver, a micro-processing unit, a memory storing unit and a switching module. The transceiver is used to receive wireless signals transmitted from one or more remotely connected devices, and the micro-processing unit is used to receive the wireless signals and allocate a plurality of service units corresponding to the remotely connected devices respectively. The aforementioned service units are used to hold the connecting channels between the Bluetooth earphone and the remotely connected devices. Moreover, the wireless signals received by the micro-processing unit are stored by the memory storing unit, and provided access to the service units. Furthermore, the switching module electrically connected with the micro-processing unit is used to switch the chosen service units according to a switching signal.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic blocking diagram of the preferred embodiment of the Bluetooth earphone of the present invention;

FIG. 2 is a schematic view of the Bluetooth earphone of the present invention;

FIG. 3 is another schematic view of the Bluetooth earphone of the present invention.

### DETAILED DESCRIPTION OF THE PREFERRED EMBODIMENTS

The present invention is illustrated with a preferred embodiment and attached drawings. However, the invention is not intended to be limited thereby.

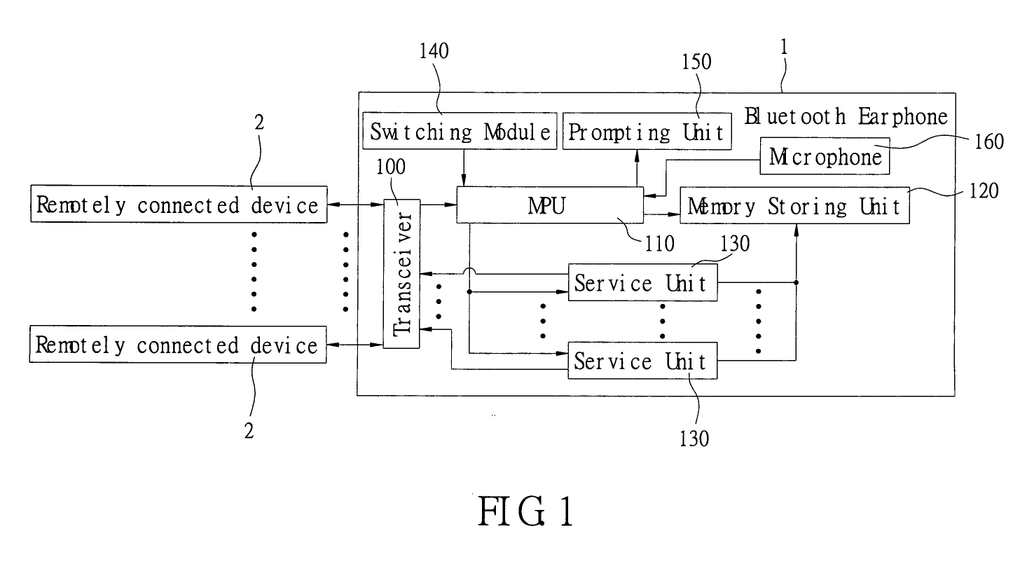

Reference is made to FIG. 1, which is a schematic blocking diagram of the preferred embodiment of the Bluetooth earphone capable of switching between multiple connections provided by the present invention. As the diagram shows, the Bluetooth earphone includes a transceiver 100, a micro-processing unit 110, a memory storing unit 120, and a switching module 140. The Bluetooth earphone 1 receives the wireless signals transmitted from at least one remotely connected device 2 via the transceiver 100. The transceiver 100 can be a wireless transmit/receive circuit having an antenna, and the remotely connected device 2 can be any of various devices such as a Bluetooth earphone, a household telephone using Bluetooth technology, a VoIP (Voice over IP) phone, a mobile phone, a signal transmission device, or a signal gateway device. Moreover, the micro-processing unit 110 is used to receive the above-mentioned wireless signals, and allocate a plurality of service units 130 corresponding to the remotely connected devices 2 respectively. The service units 130 are formed by firmware or software, and can also be a service structure with a Finite State Machine. The service units 130 are used to hold the connecting channels between the Bluetooth earphone 1 and the remotely connected devices 2, so as to maintain communication therebetween. Alternatively, the wireless signals transmitted from the remotely connected device 2 and received by the micro-processing unit 110 are stored by the memory storing unit 120, and provided to service units 130 for data accessing. Finally, the switching module 140 outputs a switching signal to the micro-processing unit 110, so as to choose the service unit 130 accordingly. The switching module 140 can be a push-button, a knob, or a switch. Moreover, since the switching module 140 switches in accordance with the various remotely connected devices 2, the micro-processing unit 110 informs the representative service unit 130 of the remotely connected device 2. After that, the service unit 130 can operate and access the memory storing unit 120. The above-mentioned accessing data can be inputted from the microphone 160 and received via the micro-processing unit 110. Finally, the data is transmitted to the remotely connected device 2 via the transceiver 100.

The Bluetooth earphone 1 further includes a prompting unit 150. When the micro-processing unit 110 chooses the service unit 130 after receiving the switching signal from the switching module 140, the prompting unit 150 transmits various alert signals to the chosen remotely connected device 2. The prompting unit 150 can be a sounding unit, a displaying unit, or an LED (light-emitting device).

The following is an illustration of the embodiments of the switching module 140 and the prompting unit 150 of the present invention. However, it is not intended that the present invention be limited thereby.

Reference is made to FIG. 2, which shows a schematic view of the Bluetooth earphone of the present invention. The switching module 140 provided is implemented as a push-button 30 in this embodiment, and the prompting unit 150 is implemented as an LED 40. For example, the push-button 30 is used to receive a signal from a remotely connected device if the push-button 30 is pushed for a short time. To receive a different signal from another remotely connected device, the push-button 30 is pushed for a long time. While the second signal is being received, the first signal will be held. Later, to choose which signal is being received, the connections between the first signal and the second signal can be switched by pushing the push-button 30 twice.

Moreover, the LED 40 with various colors can be used to distinguish the order of the different connections to the remotely connected devices. The color of the LED 40 changes as the connections are switched.

Furthermore, the above-mentioned prompting unit (150) can produce various sounds via the sounding unit (not shown), so as to distinguish which signal from a remotely connected device is currently being received.

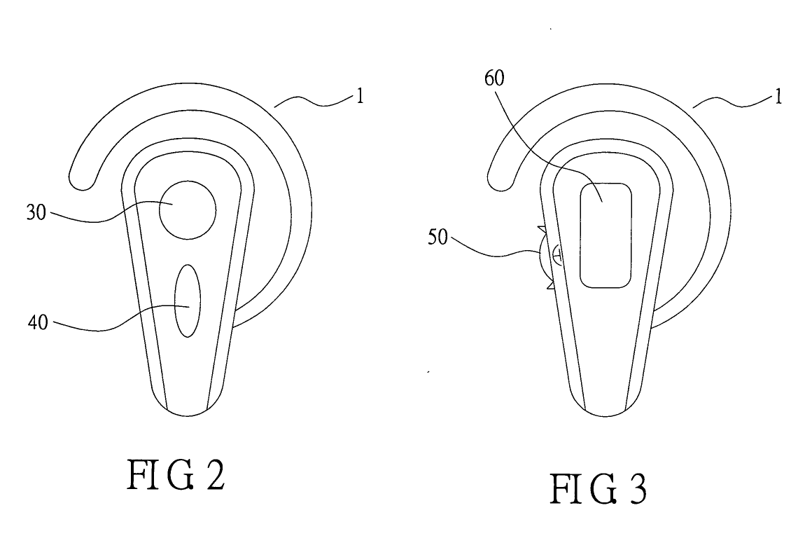

Referring to FIG. 3, which shows another schematic view of the Bluetooth earphone of the present invention, wherein the provided switching module (140) is implemented as a knob 50 and the prompting unit (150) is indicated via a displaying unit 60.

For example, similar to the previous embodiment, the knob 50 is used to receive a signal from a remotely connected device if the knob 50 is pushed for a short time. To receive a different signal from another remotely connected device, the knob 50 is pushed for a long time. After receiving the second signal, the first signal will be held. After that, the connections of the first signal and the second signal can be switched to choose which signal is in progress by turning the knob 50 up or down.

Moreover, the displaying unit 60 can be used to show various indications or codes to distinguish the connecting order of the different connections to remotely connected devices. The indications or codes shown in the displaying unit 60 are used to recognize the chosen remotely connected device when switching the connections.

In summation of the description above, the present invention expands the uses of Bluetooth communication devices providing users with a more convenient device. In the practice of the present invention, the connections between the Bluetooth earphone (1) and the remotely connected devices (2) can be switched if multiple connections therebetween are in progress.

While the invention has been described by means of a specification with accompanying drawings of specific embodiments, numerous modifications and variations could be made thereto by those skilled in the art without departing from the scope and spirit of the invention set forth in the claims.

What is claimed is:

1. A Bluetooth earphone capable of switching between multiple connections, comprising:
a transceiver, used to receive wireless signals transmitted from at least one remotely connected device;
a micro-processing unit, used to receive the wireless signals, and allocate a service unit for each remote connective unit;
a memory storing unit, used to store the wireless signals received by the micro-processing unit, and used to provide access via the service units;
a switching module electrically connected with the micro-processing unit, used to output a switching signal to the micro-processing unit;
wherein the micro-processing unit selects one of the service units according to the switching signal, and connects with one of the remotely connected devices.

2. The Bluetooth earphone of claim 1, wherein the transceiver is a wireless transmit/receive circuit having an antenna.

3. The Bluetooth earphone of claim 1, wherein the remotely connected device is another Bluetooth earphone, a telephone with a Bluetooth connection, a VoIP phone, a mobile phone, a signal transmitting device, or a signal gateway device.

4. The Bluetooth earphone of claim 1, wherein the service unit is formed by firmware or software.

5. The Bluetooth earphone of claim 4, wherein the service unit has a service structure with a Finite State Machine.

6. The Bluetooth earphone of claim 1, wherein the service unit is used to hold the connecting channel between the Bluetooth earphone and the remotely connected device.

7. The Bluetooth earphone of claim 1, wherein the switching module is a push-button, a knob, or a switch.

8. The Bluetooth earphone of claim 1, further comprising a prompting unit, which is used to announce various alert signals as the micro-processing unit chooses the service unit by switching the switching module.

9. The Bluetooth earphone of claim 8, wherein the prompting unit is a sounding unit.

10. The Bluetooth earphone of claim 8, wherein the prompting unit is a displaying unit or an LED.
